(19) United States
(12) Patent Application Publication
(10) Pub. No.: US 2003/0046365 A1
(43) Pub. Date: Mar. 6, 2003

(54) System and method for caching content

(75) Inventors: Irwin Pfister, La Jolla, CA (US); Michael A. Montgomery, Cedar Park, TX (US); Bertrand du Castel, Austin, TX (US)

Correspondence Address: MR. PEHR JANSSON, SCHLUMBERGER TECHNOLOGY CORPORATION, 8311 NORTH FM 620, AUSTIN,, TX, 78726, US

(73) Assignee: Schlumberger Technology Corporation

(21) Appl. No.: 09/946,112

(22) Filed: Sep. 4, 2001

(51) Int. Cl. G06F 15/16

(52) U.S. Cl. 709/219

(57) ABSTRACT

A system and method of caching is provided. A method for caching includes determining one or more characteristics of content; and identifying the content into one or more subsets according to the characteristics of the content, the identifying enabling transmission of at least one of the subsets for caching.

### BACKGROUND OF THE INVENTION

1. Field of the Invention

The present invention relates to the field of caching, and, more particularly, to a system and method for caching content configured for transmission via a communication channel such as transmitted document contents.

2. Description of the Related Art

Computers are often connected together in a network so the computers can share data. When information is transferred between computers, a computer predominantly responsible for sending data is often referred to as the host or server computer. A computer that predominantly receives the data is sometimes referred to as the receiving or client computer.

Current technological limitations sometimes slow the transfer rate of data between computers. The term “transfer rate” describes the amount of time that it takes for one computer to send a given amount of information to another computer. Using a slow transfer rate, a computer takes a relatively long time to transfer a given amount of information to another computer. Slowed transfer rates can normally be attributed to mechanical issues, to technological limitations in electrical components, and to the sheer volume of information server computers transfer in complex networks.

One way to lessen the impact of slow transfer rates is through caching. Caching describes the practice of storing recently used data in a receiving computer's local memory after the data is transferred to the receiving computer. Caching can allow faster overall access time to data being retransmitted because the receiving computer can normally access its local memory much faster than it can get retransmitted data from the sending computer.

A caching system is normally limited because the amount of memory allocated to the cache is generally too small to hold all data that is ever transferred. Once a cache is filled and new data comes in, a caching system must decide which data to keep and which data to overwrite. Caching systems use different techniques in deciding which of the transferred data to store in cache and which data to delete. The underlying strategy is to somehow predict future data needs so the receiving computer can access more data from cache and less data through time-consuming transfers across a network. One common method is to use a Least Frequently Used (LFU) approach In this system, as new data comes in, the least often asked for data in cache is discarded. Another common caching system is based on the Least Recently Used (LRU) approach. That is, as new data comes in to be stored in cache, the system throws away the data that was requested the longest time previously. In essence, as the name suggests, the LRU approach discards the data that has been accessed least recently.

Another limitation for caching systems is the granularity of the information being cached. For the cache to be effective, the data in the cache must precisely match the data that would otherwise be transferred. If even a single bit of the data does not match, the contents stored in the cache is useless. Thus, a document cached as a single large file would need to be retransmitted in its entirety if even a single letter is changed.

Yet another limitation for caching systems is the mechanism for identifying whether the cached contents matches the data on a remote machine. In many cases, the matching is based on a date stamp. If the date stamp matches, the cached contents can be used. If it does not, then entirely new contents must be downloaded. Often the date stamp comparison is limited to the main file, so that if the main is marked as changed, all subfiles must also be downloaded. Thus, the benefits that might otherwise be derived from small granularity are lost since the cache cannot determine which subfiles are useful and, therefore, all subfiles must also be downloaded.

Caching systems are used when a receiver computer receives information from a server using the Internet. The Internet in general is a complex, world-wide collection of computer networks. The Internet works on the client/server model of information delivery. The Internet makes it possible for computers world-wide to share information and messages.

There are numerous ways for a user to connect to the Internet. Individuals often link to the Internet by connecting to an Internet service provider (ISP) using a modem and a phone line. Other popular means for individuals to connect to an ISP include using a cable modem or a wireless system. Hand-held devices, such as wireless telephones and personal digital assistants (PDAs), are often linked, using various technologies, to the Internet for sending and receiving information. Some users access the Internet through a television set using WebTV. In short, there are ever-increasing ways, not limited to computers, to access the Internet.

The World Wide Web (Web) is a popular protocol for accessing information from the Internet. On the Web, information is stored in documents on Web sites that are usually accessible to other users on the Web. To access information on the Web, a user needs a web client, more commonly called a browser. The browser sends instructions to a server computer on the Web and retrieves a specific Web document or page. The browser allows a user to access different Web sites, download information from the Web site, and display the information on the users local computer.

Today, a browser allows a user to access different sites on the Web by using a universal resource locator (URL). The URL is essentially an address to tell the browser where to go to get information. Information is stored at the URL address in what is commonly referred to as a Web page. Sometimes, a Web page contains more than one file that may be displayed side by side. In this case, each individual file is called a “frame” and each frame has its own URL.

One example of such a server is referred to as a Web server. The Web server is responsible for sending data, such as web pages. When a receiving computer requests a web page, the files that make up that web page are downloaded using the limited bandwidth of the communications equipment and the limitations of the Web server. In one caching scenario, a web browser on the receiving computer saves time by using cache to store old files related to the requested web page. The receiving computer only downloads the newest data associated with the requested web page. The practice of storing old files is commonly referred to as “web page caching.” Web page caching reduces the volume of data that a Web server supplies the receiving computer because old pages already stored in cache are not downloaded again. The reduction in the volume of data sent reduces the transfer rate of a given number of pages. Also, Web page caching results in reduced accessed times for receiving computers because Web servers can handle reduced output volumes more rapidly than higher output volumes.

Web browsers generally combine the functions of fetching data in a file, figuring out where the data is, and displaying some of the data. A web browser uses a standardized interface protocol, such as HyperText Transfer Protocol (HTTP), to make a connection via the Internet to other computers known as web servers, and to receive information from the web servers that is displayed on the user's display. Information displayed to the user is typically organized into pages that are constructed using a specialized language such as Hypertext Markup Language (HTML), Extensible Markup Language (XML), and Wireless Markup Language (WML), hereinafter (markup languages).

Markup languages are typically based on the Standard Generalized Markup Language (SGML). SGML is a standard language for defining the format in a text document that allows sharing of documents among computers, regardless of hardware and operating system configurations. WML is used for wireless networks and is based on the standard Handheld Device Markup Language (HDML). HDML is a subset of HTML and SGML. Markup language files use a standard set of code tags embedded in text that describes the elements of a document. The web browser interprets the code tags so that each computer having its own unique hardware and software capabilities is able to display the document while preserving the original format of the document. An SGML document uses a separate document type definition (DTD) file that defines the format code tags embedded within the file.

Many Web pages are stored in Hypertext Markup Language (HTML) format. HTML is a markup language used to create Web documents. A browser decodes HTML symbols in Web documents, turning them into formatted documents with graphics and text. Two general parts of an HTML file include text, which is displayed word for word on a Web page, and HTML markup information that contain display information such as normal text, colored hypertext, or bold headers. HTML files may also contain many other kinds of information, such as elements, tags, anchors, hyperlinks, URL's and attributes.

Other programming languages are used with, or instead of, HTML and XML to enhance Web browsing. For example, Java is a language that can be used to add animation and real-time interaction to a Web site.

When downloading data from a web page, often a large percentage of the data is relatively static in nature. For example, when downloading a typical HTML page such as www.yahoo.com, more than 90% of the content is the same from week to week. However, each time the page is downloaded, all data from the page is usually downloaded, including the information that has not changed since the last download, since the caching is based on the date stamp of the main page. If the data stamp on the main page has changed, reflecting any change whatsoever to the web page, the entire contents of the page must be downloaded again. Current Web caching strategies based on LFU and LRU algorithms using date stamps are not adequate. Furthermore, network bandwidth is becoming more and more of a premium. In particular, many mobile computing devices connect to a network using a wireless channel with very limited capacity or with a fee based on the amount of data transferred. Accordingly, there is a need to reduce the amount of bandwidth used during downloads by reducing the amount of unnecessary information that is downloaded.

What is needed is a method for caching data that is more efficient than known LFU and LRU date stamp based techniques.

### SUMMARY OF THE INVENTION

Accordingly, a system and method of caching is provided that identifies content for caching according to characteristics of the content. More particularly, an embodiment is directed to a method for caching including determining one or more characteristics of content; and identifying the content into one or more subsets according to the characteristics of the content, the identifying enabling transmission of at least one of the subsets for caching. In one embodiment the characteristics include a static characteristic and a dynamic characteristic. Further, the characteristics of content may be determined with respect to a linked set of files for a web site, the linked set of files having a hierarchy, the characteristics including a plurality of levels of hierarchy in the linked set of files.

Another embodiment is directed to a method of managing content configured to for downloading from a remote computer, The method includes reading a unique identifier, the unique identifier identifying content chosen for caching according to at least one characteristic of the content; comparing the unique identifier to a list of unique identifiers; and if the list holds the unique identifier, retrieving the content identified by the unique identifier from a cache.

Another embodiment is directed to a system including a processor, a memory coupled to the processor, an instruction set operable with the processor to compare a unique identifier with a list of unique identifiers in the memory to determine whether content identified as having at least one static characteristic is stored in the memory, a transmitter responsive to the determination of the instruction set, the transmitting device configured to send a request for the content with the static characteristic when the memory lacks the unique identifier, a receiver coupled to receive the content, and the memory coupled to the receiver wherein the memory stores the content with the static characteristic and stores the unique identifier in the memory.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a network showing content flow according to an embodiment of the present invention.

FIG. 2 illustrates a block diagram of a method for the transmitting content according to an embodiment of the present invention.

FIG. 3 illustrates an embodiment of a network for showing Internet content according to an embodiment of the present invention.

FIG. 4 illustrates a sample web page appropriate for implementing embodiments of the present invention.

FIG. 5 illustrates a flow diagram of an embodiment of a method for identifying content according to an embodiment of the present invention.

FIG. 6 illustrates a flow diagram of an embodiment of a method for receiving content according to an embodiment of the present invention.

FIG. 7 illustrates a computer system appropriate for embodiments of the present invention.

### DETAILED DESCRIPTION

The following description provides a detailed description exemplary of the invention and should not be taken as limiting of the invention itself. Rather, any number of variations may fall within the scope of the invention that is defined in the claims following the description.

The present invention provides a method and system for caching content through determining characteristics of the content and identifying the content for caching purposes based on those characteristics. There is a plurality of environments for which caching based on characteristics of the content efficiently enhances transfer rates and system performance. This is in contrast to conventional systems, which cache based on properties which are independent of the contents of the file, such as date stamps or file names. For purposes of this disclosure “characteristics of the content” shall mean characteristics inherent to the content and relative to caching, independent of metadata such as file names, date stamps and the like.

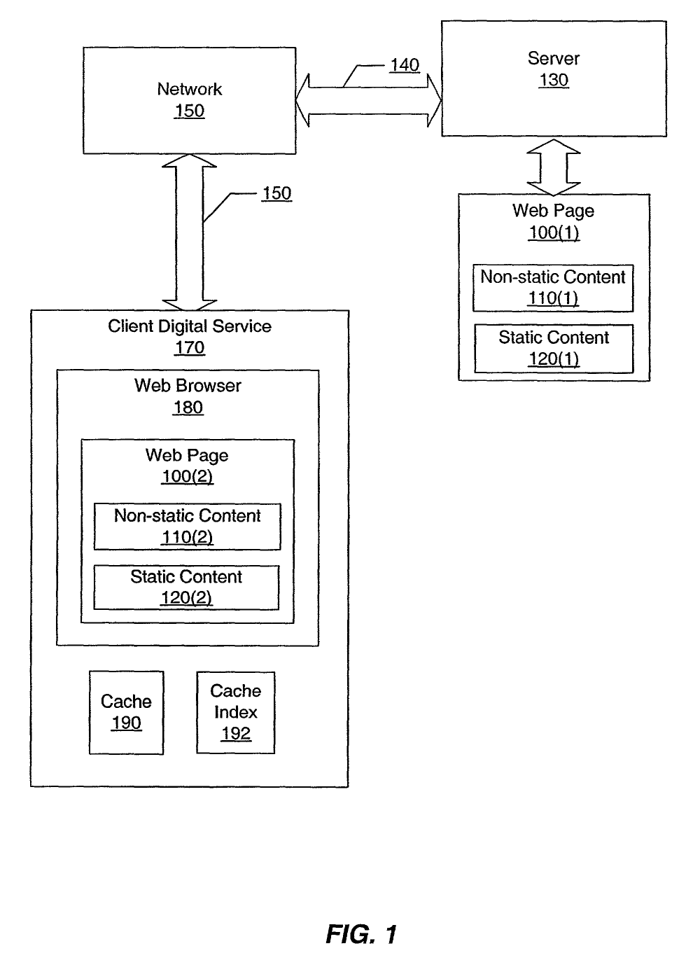

Referring to FIG. 1, one embodiment is directed to a computing environment, specifically, an Internet computing environment. Specifically, FIG. 1 illustrates a server 130, such as a server computer connected to an Internet environment.

In the embodiment, server 130 is linked to a network to practice the invention. Included within server 130 is a transmitting device, such as a modem to direct a network connection to a remote server via a telephone link, wireless link, satellite link or the like, or to the Internet via internet service provider (ISP) 150. One embodiment may be directed to a direct connection to a remote server via a direct network link such as a direct link to the Internet via a POP (point of presence). The wireless techniques for connecting to the Internet or other location may include a digital cellular telephone connection, a Cellular Digital Packet Data (CDPD) connection, and a digital satellite data connection or the like.

When server 130 connects to the Internet, server 130 is able to access and/or download information using, for example, a web browser. An example of the type of information accessed includes the pages of a web site hosted on by the server 130, shown as web page 100(1). Protocols for exchanging data via the Internet are well known to those skilled in the art. While the Internet can be used by computer 130 for exchanging data, the present invention is not limited to the Internet or to any network-based environment and, as described above, may operate in a stand-alone environment wherein transmission of content is performed between a server and another entity.

The web browser running on computer 130 can employ a TCP/IP connection. Server 130 may run, for example, an HTTP “service” (e.g., under the WINDOWS® operating system) or a “daemon” (e.g., under the UNIX® operating system), for example. Server 130, then may employ a protocol that can be used to communicate between to a client, such as client digital device (CDD)170. The server 130 responds any requests received by a CDD, typically by sending a web page formatted as an hypertext markup language (HTML) file, extensible markup language (XML) file, or wireless markup language (WML) file. The web browser interprets the file and may form a visual representation of the file using local resources of the given CDD 170, such as locally available fonts and colors. Further, server 130 and CDD 170 may support a number of Internet access tools, including, for example, an HTTP-compliant web browser having a JavaScript interpreter, such as Netscape Navigator®, Microsoft Explorer® and the like.

The particular computing environment shown in FIG. 1 is one in which server 130 is coupled to transmit Web page 100(1), which may be an HTTP-compliant web browser or other web browser. Web page 100(1) includes content with different characteristics. In one example, Web Page 100(1) holds non-static content 110(1) and static content 120(1), where the infrequently changing static content is cached, and the more frequently changing non-static content is not cached. Although other characteristics of the content may be appropriate for distinguishing content on a Web page, in one embodiment, the static characteristic advantageously provides criteria for caching different portions of a single Web page. The definition of a static characteristic may be according to design requirements, allowing multiple levels of a static state. For example, whether content is static or dynamic may be a binary determination. In other embodiments, static content may include subsets related to other caching schemes, such as static content with subcategories, as will be appreciated by those of skill in the art with the benefit of this disclosure. Conversely, the dynamic characteristic of may include multiple levels of a dynamic state.

Server 130 is shown coupled to a network 150, which may include one or more Internet Service Providers (ISPs) via a transmission vehicle 140. In other embodiments, the network and the server 130 may not require a separate transmission vehicle 140, for example, if the Server includes network functionality and directly communicates with client type devices.

FIG. 1 further shows a second transmission vehicle 160 for communications between network 150 and a client digital device (CDD) 170, which may be a second computer, a hand held device, such a mobile telephone with Internet functionality, a personal digital assistant (PDA), a mobile Internet device, or the like. CDD 170 is shown including a Web browser 180 configured to display a Web page 100(2), which may be a copy of Web page 100(1) as received via transmission vehicle 160. In one embodiment, the Web page 100(2) is a copy of Web page 100(1) and Web page 100(2) holds non-static content 110(2) and static content 120(2) as defined in Web page 100(1) or files and data associated with Web page 100(1).

CDD 170 further includes at least a cache 190 and a cache index 192. Cache 190 and cache index 192 are coupled to enable identifying cache content associated with an identifier within cache index 192. Static content 120(2) includes an identifier that is compared with the cache index 192 to determine if the static content is already present in the cache. If the static content 120(2) is already present in the cache, the static content 120(2) is not transmitted by Server 130. Instead, the Web Browser 180 retrieves the static content 120(2) from the cache 190. Otherwise, the static content 120(1) is transmitted by Server 130, and is stored in cache 190, and the cache index 192 is updated to include the identifier associated with static content 120(2).

In contrast, a conventional approach requires a change to the non-static content 110(1). The change would be reflected in a new date stamp for web page 100(1), thus requiring a later transmission of the entire page, including the static content 120(1), even if the cache already held static content 120(2).

The transmission vehicle 160 shown between ISP 150 and CDD 170 may alternatively be a wireless connection. The wireless connection may be according to one of a plurality of wireless standards, such as Bluetooth (also called Wi-Fi), 802.11b, 3G, and others. In general, Bluetooth is a short-range radio technology that links devices for automatic data exchange. 802.11b is an intermediate-range wireless networking standard that runs at speeds comparable to standard Ethernet. 3G is a cell phone technology, with a range of several miles from a cell tower or a repeater station, intended for broadband cell phone connections.

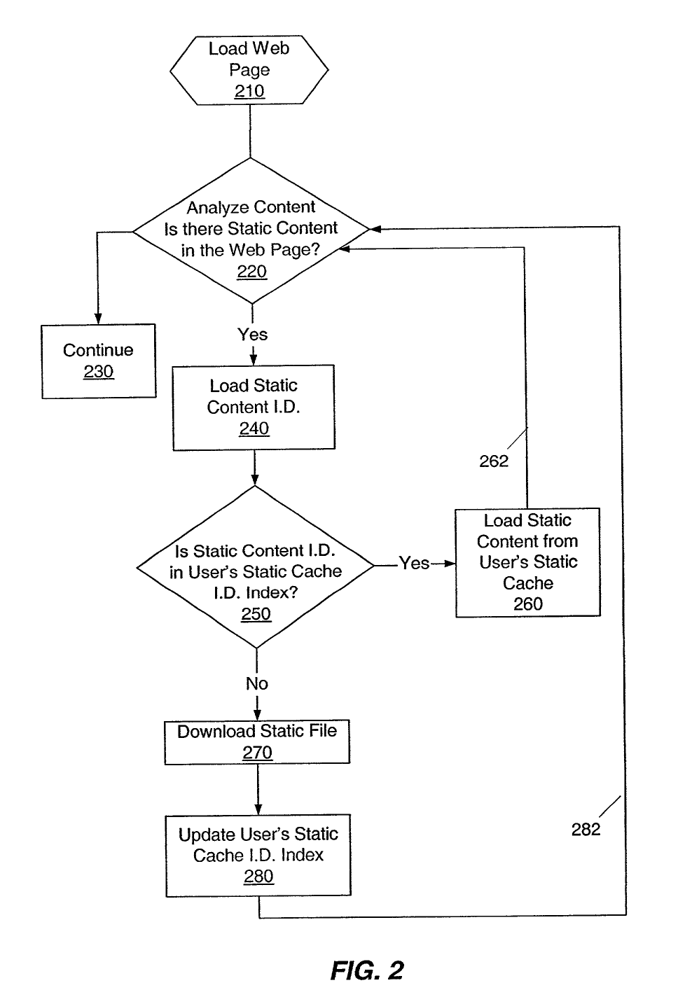

Referring now to FIG. 2, a flow diagram according to an embodiment of the present invention describes one method of caching based on content characteristics. Block 210 provides for loading a web page. For example, CDD 170 may load a web page via transmission vehicle 160. Block 220 provides for analyzing the content of the Web page, such as Web page 100(2). Specifically, in one embodiment, the analysis includes determining whether there is static content in the Web page. If there is no static content, or if there is no content identified according to a specific characteristic or characteristics, block 230 provides for continuing the loading of the web page and further processing as is known. If there is static content in the Web page, block 240 provides for checking for a static content identifier. In one embodiment, the static content identifier is a unique identifier determined by a content provider or a party with the responsibility of determining the characteristics of the content.

If one or more static content identifiers are found in block 240, block 250 provides for matching the static content identifier to a list of static content identifiers in a cache index, such as cache index 192. If cache index 192 holds the static content identifier, block 260 provides for loading static content from cache, such as cache 190 shown in FIG. 1. In one embodiment, the cache 190 from which static content is loaded is a separate static cache, with an associated static content cache index. As one of skill in the art appreciates, a static cache will be according to design requirements, taking into account factors such as the allowable memory available in a CDD 170. After loading the static content, the method continues by returning, as shown by line 262, to analyze the content received in a loaded web page 220.

If, at block 250, no static content identifiers are found in a cache index, block 270 provides for downloading static contents and storing the static contents in cache 190. Block 280 provides for updating the cache index to include an identifier associated with the stored static contents stored in cache. The method continues, as shown by line 282, with continuing the analyzing of content of the Web page. If no further static content is found, the method ends upon completion of locating all identified static content. As will be appreciated, the method may repeat for each Web page and each sub-portion of a Web page as needed.

In one embodiment, the method of FIG. 2 provides that static content portions of various WML or HTML pages are cached the first time they are read, either in a smart card or on a disk, or other storage device, or on a combination of storage devices. Upon each subsequent reference, the dynamic content is downloaded. In the embodiment, the dynamic content identifies the static content upon which the dynamic content is built. If the cached static content matches the identification, the cached static content is loaded along with the dynamic content to present the web page. Otherwise, the cached version of the static content is refreshed with a current version of the static content.

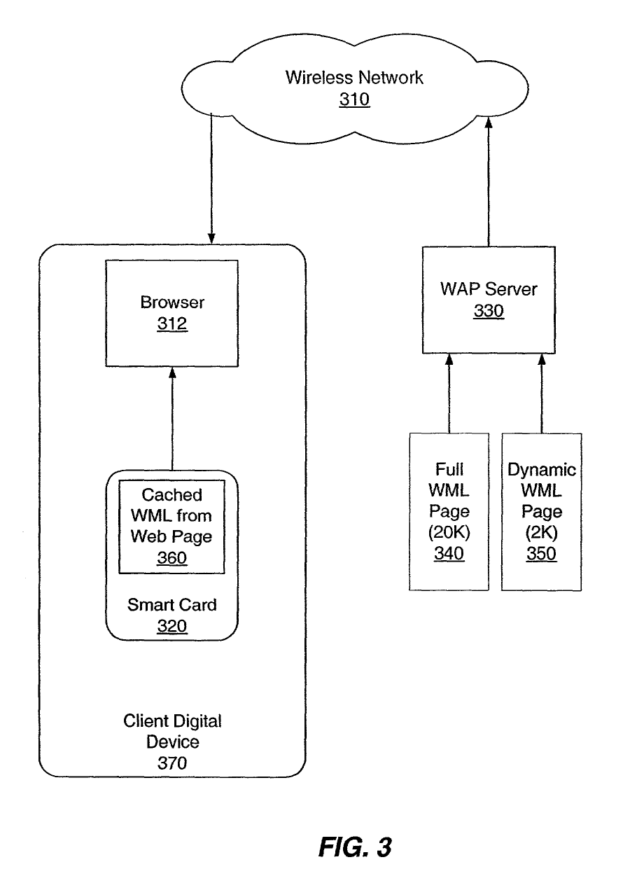

Referring now to FIG. 3, one embodiment of the invention is directed to a wireless environment, for example, a wireless environment following a wireless transmission standard such as Bluetooth or 802.11b or the like. In the embodiment, a wireless network 310 couples to a Wireless Application Protocol (WAP) server to a mobile WAP browser 312. WAP server 330 is coupled to receive web pages, such as pages 340 and 350, each are shown as a full Wireless Markup Language (WML) page holding, for example, 20 Kbytes of data 340, and a dynamic WML page 350 holding, for example 2 Kbytes of data. WML is designed for wireless uses because WML delivers a limited subset of markup properties with web text, based on the World Wide Web Consortium (W3C) guidelines for mobile access.

WAP provides a universal open standard for providing Internet content and other services to mobile phones and other wireless devices. Thus, for example, CDD 170 shown in FIG. 1 may operate under a WAP standard when CDD 170 is implemented as a mobile phone or personal digital assistant (PDA) or the like coupled to a wireless network 310.

The modulation used for wireless networks may include Time Division Multiple Access, (TDMA), Code Division Multiple Access (CDMA), or iDEN. Each of these transport modulation technologies requires an application protocol, such as the Wireless Application Protocol (WAP). WAP is a transport protocol similar to HTTP, which works over different kinds of networks. WAP generally takes less bandwidth than HTTP or similar non-wireless protocols.

Using WML templates, web designers produce web pages for presenting data to WML devices. Some Web pages using WML are flat files, but more often they are templates for the presentation of dynamic data. WML devices, such as mobile telephones, may include specialized web browsers, such a microbrowsers, that are permanently installed during a manufacturing process. For example, Phone.com™ provides a 300-Kbyte microbrowser that uses the telephone's screen to display web pages served in the wireless markup language (WML). Other known microbrowsers include AT&T's™ PocketNet™ service, and Bell Atlantic Mobile's™ Cellscape™.

Referring back to FIG. 3, CDD 370, holds a browser 312, which may be implemented as a mobile WAP browser, a microbrowser or reduced instruction set browser of a size chosen by a user or may be a fixed size microbrowser burned into the device in manufacturing. The device may be coupled to a removable or permanent smart card 320.

In general, a smart card for purposes herein is a device with a microprocessor or memory embedded therein. The memory may store electronic data and/or programs. A smart card may include enough processing power to serve many different applications. A smart card may be a memory card that stores data and may include security features. A smart card may also be a microprocessor card capable of adding, deleting and/or manipulating content and information in a memory on the smart card. A smart card may be akin to a miniature computer, with an input/output port, operating system, and EEPROM with optional built-in security features.

In the embodiment, smart card 320 includes static content of a WML web page 360. The static content 360 held in smart card 320 may be personalized according to a user's requirements. In one embodiment, a content provider for a web site, such as www.yahoo.com may subsidize the smart cards to promote access to www.yahoo.com. For example, Yahoo!® might subsidize the inclusion of the static content of web site on a smart card. The subsidizing or other arrangement to preload a smart card advantageously provides a faster loading time for a user. Thus, a user may select Yahoo!® as a default portal, thereby guaranteeing that the web site will receive more “hits” or be used more often, which will affect the prices a web site may dictate for advertising expenses. Additionally, the caching methods for only newer content on the web site provides an efficient added benefit, or “value add,” for the consumer. Other web sites, or competing portals, may receive less traffic from users with pre-loaded smart cards because the loading time and cost would be greater. For example, a competing portal such as Alta Vista® at www.altavista.com, which would necessarily load more slowly since no content is locally cached, and at much greater expense if there is a charge for data transmission

Additionally, security aspects of a smart card may provide significant advantages for certain static content. For example, static content personalized in the card could include secret keys used for cryptography, where the risk of compromising the keys is greatly reduced by storing the keys in a highly secure smart card.

The smart card may be used with a mobile telephone or a personal digital assistant as described above. In one embodiment, embodiments of the caching system described herein provide an economical method of downloading content when downloading is priced on a per byte basis. For example, mobile telephone users may pay for each block of downloaded content, at $0.05 per 256 bytes. With the embodiments described, smaller content downloads are less expensive. Thus, a preloaded smart card can save the end user a considerable amount of money in transmission fees when accessing the cached web site.

In operation, without a smart card 320 in accordance with an embodiment, when browser 312 accesses or attempts to access a particular WML page, browser 312 typically must load the full WML page 20 via the WAP server 330 through the wireless network 310. A WML page may require loading of, for example, 20 Kbytes of content into CDD 370. If smart card 320 is present, however, the browser 312 first detects that the static portion of the WML page 360 is available on smart card 320, and downloads only the 2 Kbytes of dynamic WML page 350.

The browser 312 in CDD 370, according to an embodiment, differentiates web pages according to characteristics of the content. More particularly, as shown, CDD 370 may include a removable or fixed smart card 320 with static portions of various WML or HTML pages personalized into smart card 320. Thus, static content need not be downloaded unless the content changed. Upon reference to such a web page, only the dynamic WML or HTML content requires downloading. The static content read from the smart card completes the web page. If the static content in the smart card has changed, it may be downloaded to update the card if the card has been set up to accept a modification.

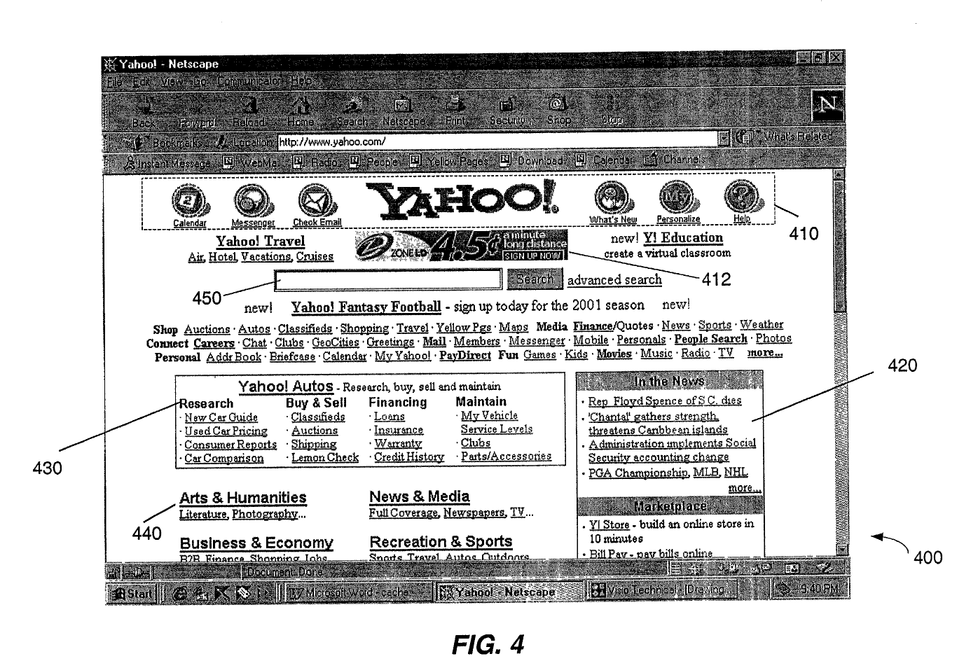

Referring to FIG. 4, a Web page 400 is shown that is appropriate for identifying content characteristics for caching purposes. As shown, Web page 400 includes a plurality of different content subsections with different characteristics. For example, the content identified as 410 includes items of content that may be predetermined by a content provider as static content. In this context, static content may mean content that may very infrequently require an alteration. As shown, the Yahoo!® label, and the icons for Calendar, Messenger, Check Email, What's New, Personalize, and Help are included in block 410. These items may be determined to be required indefinitely, or at least require a major overhaul of the web page before any changes would be made to the content. Accordingly, an embodiment of the present invention would be directed to identifying block 410 as static content in a template for the web page. Thus, a unique identifier may apply to identify the static content on the template for the web page. A user downloading the web page that loads the unique identifier, such as a static content identifier, may then check a static cache index and load the content from a static cache instead of from the web page. Prior art web page downloading requires downloading an entire web page when a single change occurs in the web page.

Advantageously, a user loading from cache for a portion of the web page avoids downloading an entire web page when one or more portions of the web page is identified as static. In a prior art web page, a single change to advertisement 412 would require downloading of the entire web page. According to an embodiment, only non-static portions of a web page designed in accordance with an embodiment require downloading when a user holds cached content of the unchanged portion(s).

For example, referring to item 412, an advertisement is identified. The advertisement may be content on the web page that often requires updating. Accordingly, an embodiment of the invention is directed to identifying item 412 as dynamic content, or content that does not have a unique identifier assigned to it because it will be downloaded at each access. In another embodiment, for example, if the advertisement is periodically changed, the advertisement 412 may have a unique identifier that lasts for as long as the period. An advertiser may pay for a six-month lease of the space on the web page, for example, and so, the content provider may provide for a unique identifier that expires after six months. After the unique identifier expires, the content appears to a user as dynamic content for which no check of a cache index is required. In another embodiment, the advertisement may have a unique identifier that changes every few hours, in cases for which an advertiser has a plurality of related advertisements that may each be associated with a unique identifier, the cache toggling or rotating the displayed cache version, for example.

FIG. 4 also shows a block 420, which is entitled “In the News.” Block 420 includes a plurality of links that are news items deemed of interest for a particular day or week or the like, as determined by a content provider. In one embodiment, the block 420 would not require a unique identifier because the content would be assumed dynamic. In another embodiment, depending on caching memory systems assumed in use on a user's platform a unique identifier may be a daily identifier for implementations in which the unique identifier is useful for users that frequently visit the web page in excess of a predetermined number of times per day.

Referring to blocks 430 and 440, a plurality of links are shown for which a different unique identifier may be assigned. More particularly, the material within block 430 may be more or less static than the items identified by block 410 or the advertisement 412. For example, the items 430 and 440 may include links that require alteration once per year, which is less often than a short-term advertisement, but more often than icons that are inherent or require no or minimal changes for long periods. Thus, blocks 440, 430, 420, 412 and 410 provide a plurality of hierarchies of content in web page 400 for which different caching strategies may be employed with the benefit of this disclosure.

Still referring to FIG. 4, in one embodiment, web page 400 may be an HTML or other markup language file written or rewritten as a linked set of files, some of which contain dynamic content, which may include the links provided in block 420, and others containing only static content, such as the items included in block 410. Further, in the embodiment, each web page included in the linked set of files that holds static content may be marked with a unique identifier, such as a standard globally unique identifier (GUID). The unique identifier, in one embodiment, ensures that the correct static content is always referenced, with no possibility of a name conflict.

According to one embodiment, when web page 400 is loaded, the linked set of files references and downloads the dynamic files 420 using conventional links. These files 420 contain references for unique identifiers to each of the static files, such as items 410, that load into various places in the web page. Each identified static file is downloaded and cached, for example, with a unique identifier stored in a standard local database, such as a cache index. The cache index identifies which static files are present in the cache. If a cache system provides that files and cache content be removed under predetermined circumstances, for example, size limitations or to reduce the cache space used, the cache index or database reflects when the files or cache content are removed from the cache. In an embodiment, for example, cache may have limited storage capacity, for example, in a readable/writeable memory. Thus, a method for caching with limited capacity may include comparing predetermined characteristics of stored content in the cache with characteristics of newly received content, the newly received content for storing in the cache, the comparing to locate stored content with predetermined characteristics, and replacing stored content with the predetermined characteristics with the newly received content in the cache. The predetermined characteristics in the stored cache may include one or more of a need for the stored content, an importance for the stored content, a cost-benefit numeric assigned to the stored content, a statistical numeric related to the need for the stored content, a mark associated with a user's desire to retain the stored content, and a characteristic identifying the stored content as unnecessary. Also, in an embodiment, the cache content can be replaced based on one or more attributes of the cache rather than the content. For example, the Least Frequently Used (LFU) and/or the Least Recently Used (LRU) algorithms, or other metric identifying frequency of access, time or date of the last access may be applied to the cache to discard or replace stored content in the cache irrespective of the content being removed.

When the web page 400 is subsequently reloaded, the dynamic files, such as items 420 are reloaded also. However, in an embodiment, any unique identifier references in any of the dynamic files is compared against the local database to determine if that particular file reference by that unique identifier is present. Because the dynamic files 420 may have been stored in the cache earlier, the unique identifier(s) is used to reload the file from the cache matching that unique identifier(s) instead of downloading the identified content from the remote system. Using the cached content identified by the unique identifier dramatically decreases the download time. Further, the embodiment advantageously provides a web page designer or content provider with flexibility, since if it later becomes necessary to change a portion of the web page which had formerly been cached, the changed version need only be assigned a new unique identifier. When the page is later downloaded, the new unique identifier will trigger a download of the changed page.

In one implementation of the embodiments described with reference to FIG. 4, a change is called for by a standards body to a standard. For example, any standard covering the format of data for transmission as a web page would accommodate the unique identifier described herein. In one embodiment, the standard may add a flag and a unique identifier for a data file for holding static content, the unique identifier labels the static content. In an embodiment, the assigned unique identifier corresponds to the identified static content indefinitely. Thus, if the static content is no longer needed, the unique identifier is abandoned. The unique identifiers are not reused. For example, in one embodiment, the unique identifier may have a 128 bit address base corresponding to a plethora of available unique identifiers. The standard would therefore enable the data file to exist such that the unique identifier(s) and static content define the file.

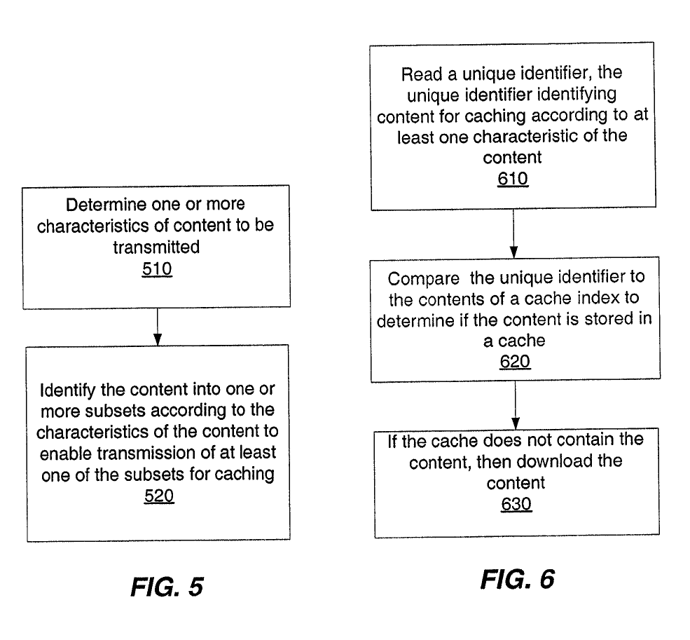

Referring to FIG. 5, a flow diagram illustrates a method appropriate for one or more embodiments. Block 510 provides for determining one or more characteristics of content to be transmitted. Block 520 provides for identifying the content into at least a first subset according to the identified characteristic of the content, the identifying enabling caching of at least the first subset of the content according to the identified characteristics. In one embodiment, the identified characteristics include a static characteristic and a dynamic characteristic. The static characteristics of content on a Web page are determined including all levels of hierarchy in the Web page. In one embodiment, the identifying is performed by a content provider.

In another embodiment, rather than a content provider providing the unique identifiers for content, a consortium of, for example, tool developers for web pages, such as Cold Fusion™ may provide the unique identifiers. Specifically, referring back to FIG. 4, a block 450 is identified as a query box for a user to enter a search query. A button “Search” is provided on the web page for a user to click after entering a search query. According to an embodiment, a consortium of software developers, or a lead software developer or a party with standardizing powers may identify the box and, perhaps, the “Search” button, as a universal item appropriate for a universal unique identifier. Other appropriate items for universal unique identifiers include simple .gifs, other graphics, common sounds, simple drawings, and other .gifs that are common on many web pages. The software developers or other party may provide a list of universal unique identifiers with corresponding common items, as appropriate, to content providers, web developers and any party that makes decisions as to unique identifiers. A content provider may then apply the universal unique identifier for those items. Thus, certain predetermined unique identifiers, such as universal unique identifiers may be standardized by a standards body.

In addition, a tool developer could select a set of unique identifiers for the static content produced by the particular tool when constructing web pages. In this case, all web designers using this particular tool would benefit from the unique static content produced. This static content would only have to be cached a single time in the client browser, regardless of the number of web pages accessed that were constructed using this tool.

From a client computer perspective, FIG. 6 provides a method of managing content. Block 610 provides for reading a unique identifier, the unique identifier identifying content for caching according to at least one characteristic of the content. Block 620 provides for comparing the unique identifier to the contents of a cache index to determine if the content is stored in a cache. Block 630 provides that if the cache is independent of the content, the content is downloaded. In one embodiment, one or more of the cache, cache index and browser is located in a smart card, such as that shown in FIG. 3.

### Other Embodiments

While specific embodiments of the present invention have been described, various modifications and substitutions will become apparent to one skilled in the art by this disclosure. Such modifications and substitutions are within the scope of the present invention. For example, an embodiment may be directed to a logging environment, a satellite communication environment or other environments for which bandwidth reductions, efficiency and cost are important.

Unlike conventional caching systems, embodiments of this invention include unique identifiers associated with specific content. A conventional system might have multiple copies of the exact same content being cached as associated subfiles of various documents, with no way to determine that the subfile contents are indeed identical. In accordance with an embodiment, a cache need only have a single copy of any unique content, marked with a unique identifier, regardless of the number of different documents that are accessed which include this content. Indeed, such unique content need only be downloaded a single time. New documents downloaded which reference this same unique content need not download this content even a single time.

Thus, many different areas can benefit from embodiments disclosed herein. For example, if a data log uses a particular static frame to display the graph, the static frame can be marked with a unique identifier and cached, and need never be loaded again when displaying this data. Similarly, stock data is often displayed on static graphs with particular time scales. The static graph for a given time scale could be marked and cached, making subsequent displays on the same time scale much faster. With certain video transmissions, a channel logo appears in the corner of the display, such as the logo associated with the Disney® Channel. The logo could be cached at the receiver, thus avoiding the transmission of the logo with every video frame. Indeed, virtually all documents have some kinds of static components, such as company logos, and could benefit from marking and caching such static components, reducing transmission times for these documents.

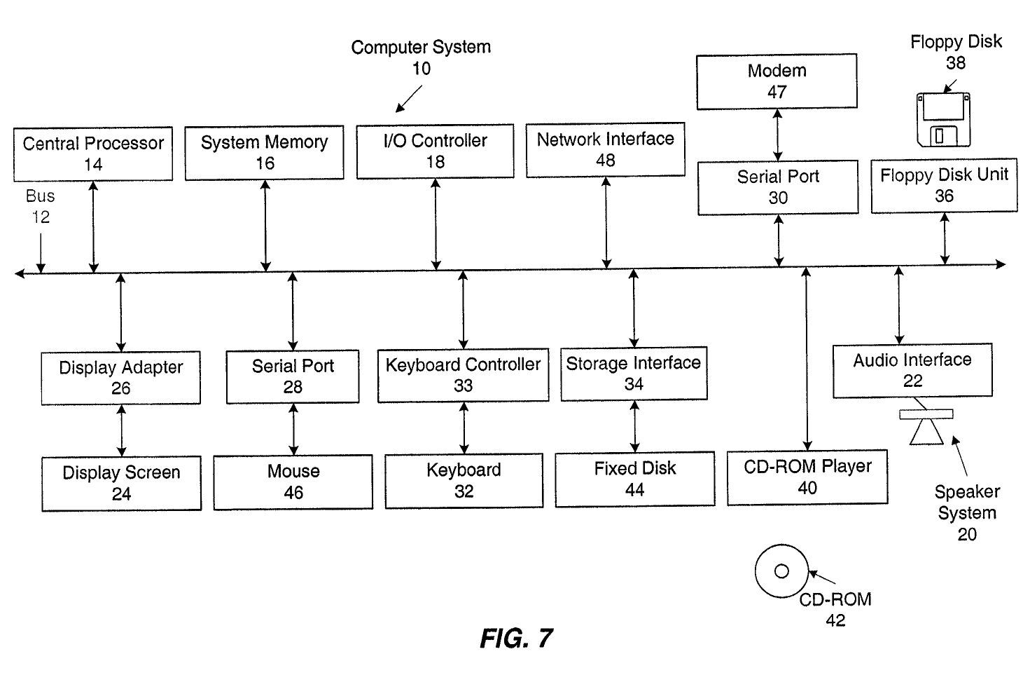

One or more of the embodiments described above provide for the use of a server, server, or other type of computer system. A computer system of any appropriate design, in general, including a mainframe, a mini-computer, such as a hand-held device or a personal computer system, may be used to practice the present invention. Such a computer system typically includes a system unit having a system processor and associated volatile and non-volatile memory, one or more display monitors and optional keyboards. Some computer systems may include one or more diskette drives, one or more fixed disk storage devices and one or more printers. These computer systems are typically information handling systems which are designed to provide computing power to one or more users, either locally or remotely. Such a computer system may also include one or a plurality of input/output (I/O) devices (i.e., peripheral devices) which are coupled to the system processor and which perform specialized functions. Examples of I/0 devices include modems, sound and video devices and specialized communication devices. Mass storage devices such as hard disks, CD-ROM drives and magneto-optical drives may also be provided, either as an integrated or peripheral device. One such example computer system is shown in detail in FIG. 7.

FIG. 7 depicts a block diagram of a computer system 10 suitable for implementing at least a portion of the present invention. Computer system 10 includes a bus 12 which interconnects major subsystems of computer system 10 such as a central processor 14, a system memory 16 (typically RAM, but which may also include ROM, flash RAM, or the like), an input/output controller 18, an external audio device such as a speaker system 20 via an audio output interface 22, an external device such as a display screen 24 via display adapter 26, serial ports 28 and 30, a keyboard 32 (interfaced with a keyboard controller 33), a storage interface 34, a floppy disk unit 36 operative to receive a floppy disk 38, and a CD-ROM player 40 operative to receive a CD-ROM 42. Also included are a mouse 46 (or other point-and-click device, coupled to bus 12 via serial port 28), a modem 47 (coupled to bus 12 via serial port 30) and a network interface 48 (coupled directly to bus 12). As will be appreciated, computer system 10, if implemented in a hand-held device will have limited space for each component described above, and will be independent of many of the devices herein described.

Bus 12 allows data communication between central processor 14 and system memory 16, which may include both read only memory (ROM) or flash memory (neither shown), and random access memory (RAM) (not shown), as previously noted. The RAM is generally the main memory into which the operating system and application programs are loaded and typically affords at least 16 megabytes of memory space. The ROM or flash memory may contain, among other code, the Basic Input-Output system (BIOS) which controls basic hardware operation such as the interaction with peripheral components. Application programs resident with computer system 10 are generally stored on and accessed via a computer readable medium, such as a hard disk drive (e.g., fixed disk 44), an optical drive (e.g., CD-ROM player 40), floppy disk unit 36 or other storage medium. Additionally, application programs may be in the form of electronic signals modulated in accordance with the application and data communication technology when accessed via network modem 47 or interface 48.

Storage interface 34, as with the other storage interfaces of computer system 10, may connect to a standard computer readable medium for storage and/or retrieval of information, such as a fixed disk drive 44. Fixed disk drive 44 may be a part of computer system 10 or may be separate and accessed through other interface systems. Many other devices can be connected such as a mouse 46 connected to bus 12 via serial port 28, a modem 47 connected to bus 12 via serial port 30 and a network interface 48 connected directly to bus 12.

Regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Those skilled in the art will also appreciate that embodiments disclosed herein may be implemented as software program instructions capable of being distributed as one or more program products, in a variety of forms including computer program products, and that the present invention applies equally regardless of the particular type of program storage media or signal bearing media used to actually carry out the distribution. Examples of program storage media and signal bearing media include recordable type media such as floppy disks, CD-ROM, and magnetic tape transmission type media such as digital and analog communications links, as well as other media storage and distribution systems.

Additionally, the foregoing detailed description has set forth various embodiments of the present invention via the use of block diagrams, flowcharts, and/or examples. It will be understood by those skilled within the art that each block diagram component, flowchart step, and operations and/or components illustrated by the use of examples can be implemented, individually and/or collectively, by a wide range of hardware, software, firmware, or any combination thereof. The present invention may be implemented as those skilled in the art will recognize, in whole or in part, in standard Integrated Circuits, Application Specific Integrated Circuits (ASICs), as a computer program running on a general-purpose machine having appropriate hardware, such as one or more computers, as firmware, or as virtually any combination thereof and that designing the circuitry and/or writing the code for the software or firmware would be well within the skill of one of ordinary skill in the art, in view of this disclosure.

Although particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

What is claimed is:

1. A method of caching, the method comprising:
determining one or more characteristics of content; and
identifying the content into one or more subsets according to the characteristics of the content, the identifying enabling transmission of at least one of the subsets for caching.

2. The method of claim 1 wherein the content is configured for transmission via a communication channel.

3. The method of claim 1 wherein characteristics include a static characteristic and a dynamic characteristic.

4. The method of claim 1 wherein the characteristics of content are determined with respect to a linked set of files for a web site, the linked set of files having a hierarchy, the characteristics including a plurality of levels of hierarchy in the linked set of files.

5. The method of claim 1 wherein the identifying is performed by a content provider.

6. The method of claim 1 wherein the identifying is via one of a standards body and a tool provider.

7. The method of claim 1 wherein the determining one or more characteristics provides a cached set of files for a smart card.

8. A method of managing content configured to for downloading from a remote computer, the method comprising:
reading a unique identifier, the unique identifier identifying content chosen for caching according to at least one characteristic of the content;
comparing the unique identifier to a list of unique identifiers; and
if the list holds the unique identifier, retrieving the content identified by the unique identifier from a cache.

9. The method of claim 8, further comprising:
if the unique identifier is not on the list, downloading the content identified by the unique identifier from a source;
adding the content to the cache; and
adding the unique identifier to the list.

10. The method of claim 9 wherein the source is a remote computer.

11. The method of claim 8, further comprising:
receiving the unique identifier via a communication channel, the communication channel including one of a wireless communication channel, a wired communication channel, a cable communication channel, and a satellite communication channel.

12. The method of claim 8 wherein the characteristics of the content include a static characteristic of the content.

13. The method of claim 8 wherein the characteristics of the content include a plurality of characteristics according to one or more of a determination as to a level of inactivity and a plurality of predetermined parameters for adjusting the content.

14. The method of claim 8 wherein the content is stored on a machine readable medium coupled to a first digital machine and wherein the first digital machine transmits the unique identifier via a communication channel to a second digital machine, wherein:
the characteristic of the content associated with a unique identifier is a static characteristic;
the comparing the unique identifier includes determining whether the list of identifiers having a static characteristic on the second digital machine holds the unique identifier; and
if the second digital machine holds the unique identifier in the list, the content is stored in a readable/writeable memory locally coupled to the second digital machine.

15. The method of claim 14 wherein the readable/writeable memory has limited storage capacity, the readable/writeable memory:
comparing the characteristics of stored content in the cache with predetermined characteristics of newly received content, the newly received content for storing in the cache, the comparing to locate stored content with predetermined characteristics; and
replacing stored content with the predetermined characteristics with the newly received content in the cache.

16. The method of claim 15 wherein the predetermined characteristics include one or more of a need for the stored content, an importance for the stored content, a cost-benefit numeric assigned to the stored content, a statistical numeric related to the need for the stored content, a mark associated with a user's desire to retain the stored content, and a characteristic identifying the stored content as unnecessary.

17. The method of claim 14 wherein the first digital machine is a Web server linked to the Internet.

18. The method of claim 14 wherein the second digital machine is one of a personal computer, a portable computing device, and a mobile telephone.

19. The method of claim 14 wherein the second digital machine is configured to execute one or more of telephony, appointment planning, and personal computing.

20. The method of claim 14 wherein the first or second digital machine is a logging device for logging oil well data.

21. A method for identifying transmitted content appropriate for caching, the method comprising:
designating the content with regard to at least one characteristic; and
obtaining a unique identifier for identifying the content as having the characteristic, wherein:
the content is one of a plurality of types of content on a template, the template configured to present the content types via a communication channel; and
the designating the content permits a receiving machine to either one of caching of the content identified as having the characteristic and avoiding of caching of the content identified as having the characteristic.

22. A system comprising:
a processor;
a memory coupled to the processor;
an instruction set operable with the processor to compare a unique identifier with a list of unique identifiers in the memory to determine whether content identified as having at least one static characteristic is stored in the memory;
a transmitter responsive to the determination of the instruction set, the transmitting device configured to send a request for the content with the static characteristic when the memory lacks the unique identifier;
a receiver coupled to receive the content; and
the memory coupled to the receiver wherein the memory stores the content with the static characteristic and stores the unique identifier in the memory.

23. The system of claim 22 wherein the apparatus is one of a smart card and a memory module coupled to one of a mobile telephone, a personal digital assistant, a personal computer, and a mobile computing device.

24. The system of claim 22 wherein the memory includes:
storage for the content with the static characteristic; and
a database for holding a list of unique identifiers.

25. The system of claim 22 wherein:
the apparatus receives the unique identifier via a communication channel in response to a request for content for loading a linked set of files defining a web page, the linked set of files including content having a static characteristic and dynamic content, wherein the content identified as having at least one static characteristic is associated with the unique identifier.

26. The system of claim 25 wherein the linked set of files includes a ranking means for ranking the content as having a static characteristic and content having dynamic characteristics according to how often the content is likely to be replaced.
